(19) United States
(12) Patent Application Publication
(10) Pub. No.: US 2013/0188486 A1
(43) Pub. Date: Jul. 25, 2013

(54) DATA CENTER NETWORK USING CIRCUIT SWITCHING

(71) Applicants: Charles P. Thacker, Palo Alto, CA (US); Andreas G. Nowatzyk, San Jose, CA (US); Fang Yu, Sunnyvale, CA (US); Thomas L. Rodeheffer, Mountain View, CA (US)

(72) Inventors: Charles P. Thacker, Palo Alto, CA (US); Andreas G. Nowatzyk, San Jose, CA (US); Fang Yu, Sunnyvale, CA (US); Thomas L. Rodeheffer, Mountain View, CA (US)

(73) Assignee: Microsoft Corporation, Redmond, WA (US)

(21) Appl. No.: 13/355,575

(22) Filed: Jan. 23, 2012

(51) Int. Cl. H04L 12/50; H04L 12/26

(52) U.S. Cl. 370/235; 370/386

(57) ABSTRACT

A circuit-based digital communications network is provided for a large data center environment that utilizes circuit switching in lieu of packet switching in order to lower the cost of the network and to gain performance efficiencies. A method for transmitting data in such a network comprises sending a setup request for a path for transmitting the data to a destination node and then speculatively sending the data to the destination node before the setup request is completed.

### BACKGROUND

Packet switching is a digital networking communications method that groups transmitted data (regardless of content, type, or structure) into suitably sized blocks or packets for delivery as variable bit rate data streams (sequences of packets) over a shared communications network. Generally packet switching is connectionless, that is, each packet includes complete addressing or routing information to enable the packets to be routed individually through the network. Consequently, packets may take different paths and arrive out-of-order at the intended destination where they are reassembled into the original data form. Moreover, when traversing network adapters, switches, routers and other network nodes, packets may be buffered and queued, which results in variable throughput and delays depending on the traffic load in the network.

Packet switching is generally used to optimize utilization of channel capacity available in digital communication networks, as well as to minimize transmission latency (the time it takes for data to pass across the network) and to increase robustness of communication. Packet switching is widely used by the Internet and most local area computer networks, and is typically implemented using the well-known Internet Protocol (IP) suite. In addition, modern mobile phone technologies (e.g., GPRS, I-mode, etc.) also use packet switching.

However, packet-switched networks use many packet switches, and packet switches are relatively expensive. Thus, many networks may benefit from architectures that reduce the number of packet switches used in their operation. For example, large data center networks typically utilize expensive commercial IP-based packet switches, but in addition to their high cost, the use of packet switches often proves problematic where high speed data processing is wanted, largely because of the amount of time and communication overhead used by packet-based systems to perform packet header processing.

### SUMMARY

A circuit-based network in a large data center environment uses circuit switching in lieu of packet switching in order to lower the cost of the network and to gain performance efficiencies.

In an implementation, a data center comprises nodal divisions, each nodal division comprising nodal groups, and each nodal group comprising nodes. The nodes in each nodal group are interconnected on a first circuit-switched network local to each nodal group, and the nodal groups in each nodal division are interconnected on a local inward facing portion of a second circuit-switched network. The nodal divisions in the data center are interconnected on a remote outward facing portion of the second circuit-switched network, and circuit switches interconnect the inward facing portion and the outward facing portion of the second circuit-switched network. The second circuit-switched network may be implemented with circuit switches comprising FPGAs, for example.

In an implementation, a circuit-switched digital communications network comprises local circuit-switched networks each comprising servers, with each server comprising a network interface controller (NIC). At least one server per local circuit-switched network comprises a NIC capable of connecting to a second network. The remote circuit switches are coupled to each local circuit-switched network via the NIC capable of connecting to the second network. The circuit switches perform switching on the second network, and the circuit switches are interconnected.

In an implementation, a method comprises sending a setup request for a path for transmitting data to a destination node, and then speculatively sending the data to the destination node before the setup request is completed.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

To facilitate an understanding of and for the purpose of illustrating the present disclosure and various implementations, exemplary features and implementations are disclosed in, and are better understood when read in conjunction with, the accompanying drawings—it being understood, however, that the present disclosure is not limited to the specific methods, precise arrangements, and instrumentalities disclosed. Similar reference characters denote similar elements throughout the several views. In the drawings:

FIGS. 1A and 1B are block diagrams illustrating an exemplary circuit-based digital communications network for a large data center representative of various implementations disclosed herein;

FIG. 2 is a block diagram providing a simplified view of an exemplary circuit-switched digital communications network reflected in FIGS. 1A and 1B representative of various implementations disclosed herein;

FIG. 3 is a block diagram illustrating an implementation of an L1 switch;

FIG. 4 is a block diagram illustrating the interconnectivity of the L1 switches in a container coupled to its half-racks;

FIG. 5 is a block diagram of part of an exemplary internal structure for the L1 switch of FIG. 3 which may be utilized by several implementations disclosed herein;

FIG. 6A illustrates an exemplary interconnection of line cards and crossbar cards for an L1 switch representative of several implementations disclosed herein;

FIG. 6B is a perspective view of the line cards, crossbar cards, and midplane of FIG. 6A;

FIG. 7 is a process flow diagram illustrating an exemplary method for setting up and tearing down connections for several implementations described herein; and

FIG. 8 shows an exemplary computing environment in which example implementations and aspects may be implemented.

### DETAILED DESCRIPTION

In contrast to packet switching, circuit switching is a methodology by which two communications network nodes establish a dedicated communications channel (or “circuit”) through the network over which to transmit data. The circuit provides the full bandwidth of the channel for the data transmission and remains connected for the duration of the communication session. As such, the circuit functions as if the nodes were physically connected like an electrical circuit. One well-known example of a circuit-switched network is the early analog telephone network where a call would be made from one telephone to another when telephone exchanges created a continuous wire circuit between two telephone handsets for the duration of the call. Although each circuit cannot be used by other nodes until the circuit is released and a new connection is established, bit delay in circuit switching is constant during the connection and there is very little overhead required. In contrast, packet switching requires the use of packet queues that may cause varying packet transfer delays and a substantial amount of overhead processing.

A field-programmable gate array (FPGA) is an integrated circuit designed to be configured at some point in time after manufacturing. As disclosed herein, FPGAs may be used to build straightforward but powerful communication networks in certain environments such as large data centers; however the use of FPGAs are only one possible implementation approach, and there are several other technologies that may be implemented, such as implementations using application-specific integrated circuits (ASICs). Nevertheless, the use of FPGAs may be desirable when implementing a medium-scale prototype of a data center network.

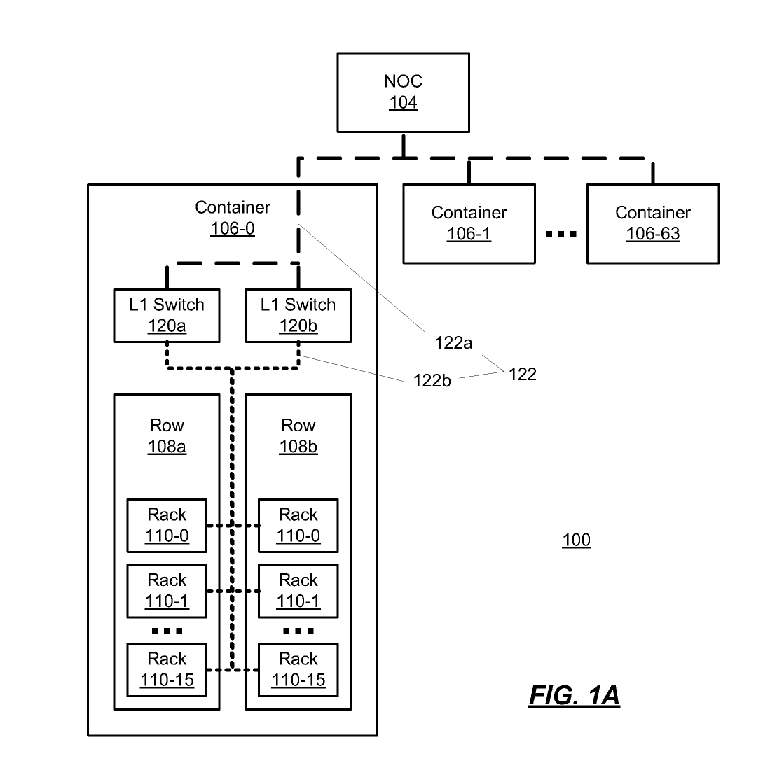

FIGS. 1A and 1B are block diagrams illustrating an exemplary circuit-based digital communications network (or “nodal network”) for a large data center 100 (or “nodal computing center”) representative of various implementations disclosed herein. Referring to FIG. 1A, a data center 100 is a hierarchical structure comprising a network operations center (NOC) 104 and sixty-four (64) containers 106-0, 106-1, . . . , 106-63 (or “nodal divisions”).

Each container (as illustrated for container 106-0 but applicable to all containers) further comprises two 128-port 10 Gb/s L1 switches 120a and 120b that, when interconnected (link the containers and/or the NOC 104), form the outward-facing portion 122a of an L1 network 122. In addition, each container comprises two rows 108a and 108b. Each row, in turn, further comprises sixteen (16) racks 110-0, 110-1, . . . , 110-15. For certain implementations, the L1 switches may be physically arranged such that each row comprises one L1 switch, although they are shown separately herein this illustration for clarity.

Referring to FIG. 1B, a rack 110 (corresponding to the sixteen (16) racks 110-0, 110-1, . . . , 110-15 of each row 108a and 108b of each container 106-0, 106-1, . . . , 106-63 of FIG. 1A) is comprised of two half-racks 112a and 112b. Each half-rack 112a and 112b (also referred to as a “nodal group” herein) further comprises a plurality of servers 114-0, 114-1, . . . , 114-n (or “nodes”) where n is equal to one less than the total number of servers in a half-rack (and thus may vary from half-rack to half-rack).

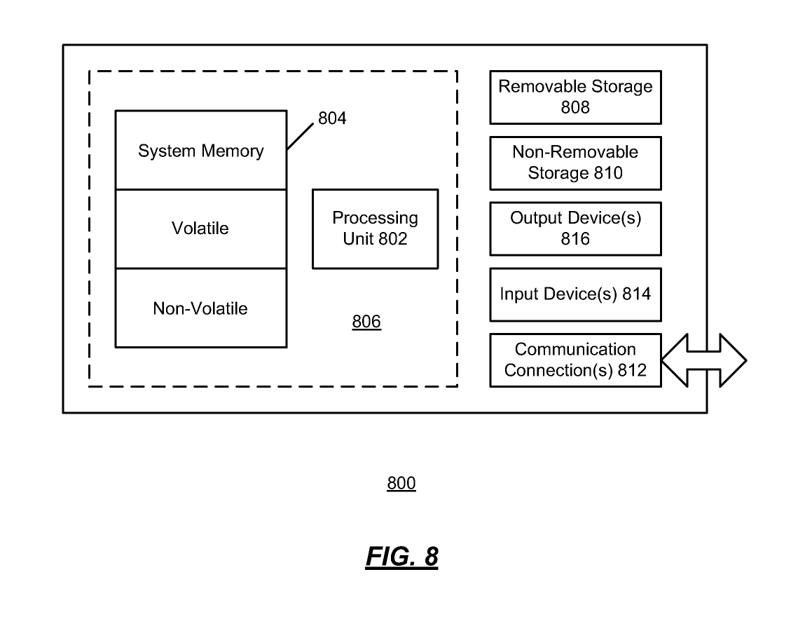

Each server 114-0, 114-1, . . . , 114-n comprises a corresponding network interface controller (NIC) 116-0, 116-1, . . . , 116-n. The NICs 116-0, 116-1, . . . , 116-n within each half-rack 112a or 112b are together interconnected to form a local L0 network 118 among the plurality of servers 114-0, 114-1, . . . , 114-n within each half-rack 112a or 112b respectively. The local L0 networks 118 within each respective half-rack 112a or 112b may be formed using any of a number of possible topologies known to skilled artisans, and may differ from half-rack to half-rack. For certain implementations, the ports in each L0 network 118 (i.e., in each nodal group) may be connected together using Serial Advanced Technology Attachment (SATA) cables. The “nodes” or servers 114-0, 114-1, . . . , 114-n in this L0 network 118 may comprise any of several types of computing devices capable of interfacing directly or indirectly with the network 102, such as a computing device 800 illustrated in FIG. 8 for example.

In several such implementations, the NICs 116-0, 116-1, . . . , 116-n may have four 5 Gb/s ports (not shown) to form the L0 networks 118 when connected together. In addition, two NICs per each half-rack 112 (e.g., NICs 116-0 and 116-1) are “egress NICs” (and along with their corresponding servers may be together referred to as “egress nodes”) which feature an additional 5th port (not shown) to connect the half-rack 112 to its corresponding container's two L1 switches 120a and 120b (as shown) and thus forms the inward-facing portion 122b of the L1 network 122 (which altogether encompasses 122a and 122b of FIGS. 1A and 1B as shown). In various such implementations, the 5th port may be a 10 Gb/s port to match the speed of the corresponding L1 switch to which it is connected.

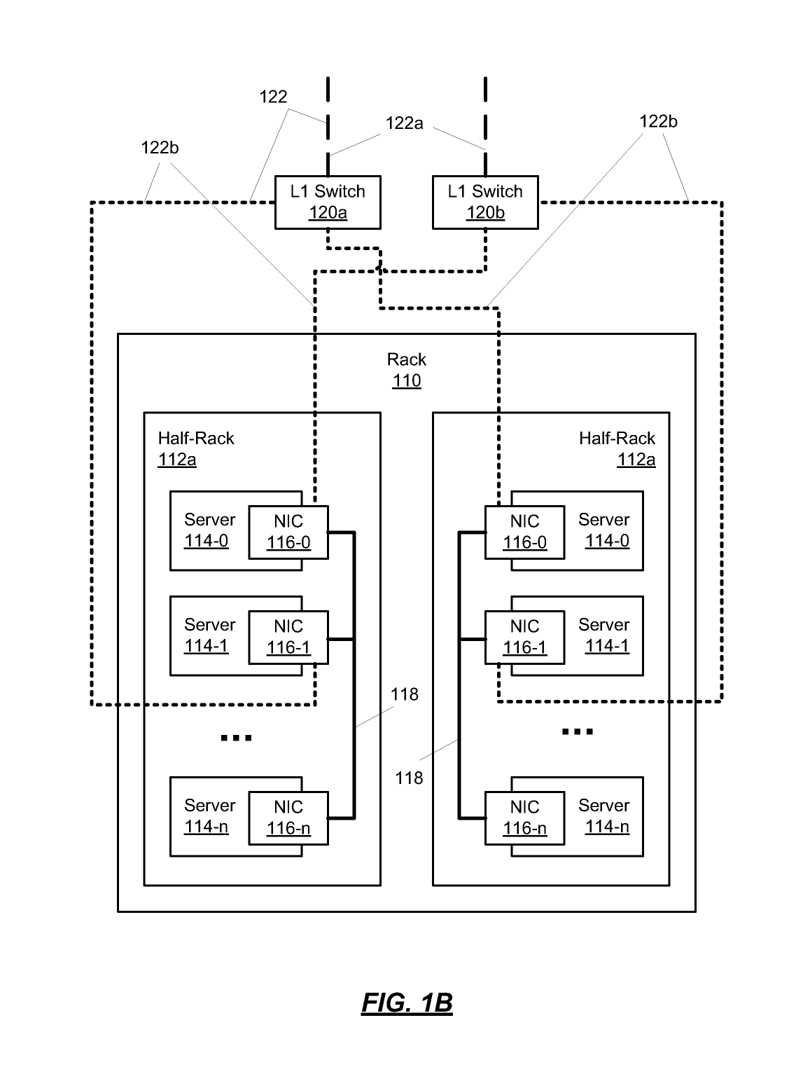

FIG. 2 is a block diagram providing a simplified view of an exemplary circuit-switched digital communications network 102 reflected in FIGS. 1A and 1B and provides a high-level representative of various implementations disclosed herein. As illustrated, only the basic organizational abstractions useful to the operation of the circuit-switched communications network are represented without regard to redundant communications or physical location of the components, although redundancy and physical location of the components can be incorporated into such implementations.

In FIG. 2, the network 102 comprises a plurality of circuit switches 120 (corresponding to the various L1 switches 120a and 120b of FIGS. 1 and 2) and a plurality of nodes 114 (corresponding to the various pluralities of servers 114-0, 114-1, . . . , 114-n in the data center 100 of FIGS. 1 and 2) that are interconnected as shown. The nodes 114 may be organized into nodal groups 112, and the nodal groups and the circuit switches 120 may be organized into nodal divisions 106. Each nodal group 112 and its member nodes 114 are identifiable and distinguishable from other nodal groups by the L0 network 118 local to and only shared by the nodes 114 of that nodal group 112. Likewise, each nodal division 106 and its switch 120 and member nodal groups 112 are identifiable and distinguishable from those of other containers by their interconnectivity (that is, by nodal groups 112 that directly connect to at least one common switch 120).

Viewed differently, the network 102 is organized as a plurality of nodal divisions 106 (corresponding to the containers 106-0, 106-1, . . . 106-63 of FIG. 1). Each nodal division 106 comprises at least one circuit switch 120 (corresponding to the L1 switches 120a or 120b of FIGS. 1 and 2) that is interconnected to each of the other circuit switches 120 in the other nodal divisions 106 to form a remote or high-level outward-facing portion 122a (denoted by dashed connecting lines) of an L1 network 122 for inter-switch communications. Each nodal division 106 further comprises a plurality of nodal groups 112 (corresponding to the half-racks 112a and 112b for each rack 110-0, 110-1, . . . , 110-15 of each row 108a and 108b of each container 106-0, 106-1, . . . , 106-63). Each nodal group is interconnected to the other nodal groups 112 within a common nodal division 106 via the at least one circuit switch 120 of that common nodal division 106. These interconnections between the nodal groups 112 form an inward-facing portion 122b (denoted by dotted connecting lines) of the L1 network 122 for communications that occur between nodal groups 122 within the common nodal division 106 (i.e., without leaving that common nodal division 106). The inward-facing portions 122b and the outward-facing portion 122a together comprise the L1 network 122 and are operatively connected via the circuit switches 120 to also allow inter-container communications (i.e., between nodal groups 112 and nodes 114 in different nodal divisions 106).

Each nodal group 112 further comprises a plurality of nodes 114 that are interconnected via a local L0 network 118 (denoted by solid connecting lines), and at least one node 114 (the “egress node”) in each nodal group 112 provides an interface between the L0 network 118 and the L1 network 122 via an additional connection between that node 114 and the circuit switch 120 for its nodal division 106. Again, these connections between the at least one node 114 for each nodal group 112 to the corresponding circuit switch 120 together comprise the inward-facing portion 122b of the L1 network 122. The circuit switches 120 in turn may connect not only to each other but also to a NOC 104 (not shown in FIG. 2).

In alternative implementations, additional switches 120 per nodal division 106 and additional nodes 114 connecting their nodal group 112 to the additional switches 120—such as illustrated in FIGS. 1A and 1B—can provide large throughput and fault tolerance and can be wisely employed, although the structure of such enhanced networks does not substantially differ from the representation shown in FIG. 2.

By organizing the data center 100 in this fashion—rather than the typical approach which uses expensive top-of-rack (TOR) switches—the data center can benefit from improved bandwidth for traffic that stays within a half rack/nodal group while avoiding the costs of TOR switches. In addition, in certain implementations the L1 switches (which are too few to make an ASIC implementation economic) may be implemented using one or more FPGAs for each, while the NICs (which are quite numerous in a large data center) might still be more economically implemented using an ASIC implementation.

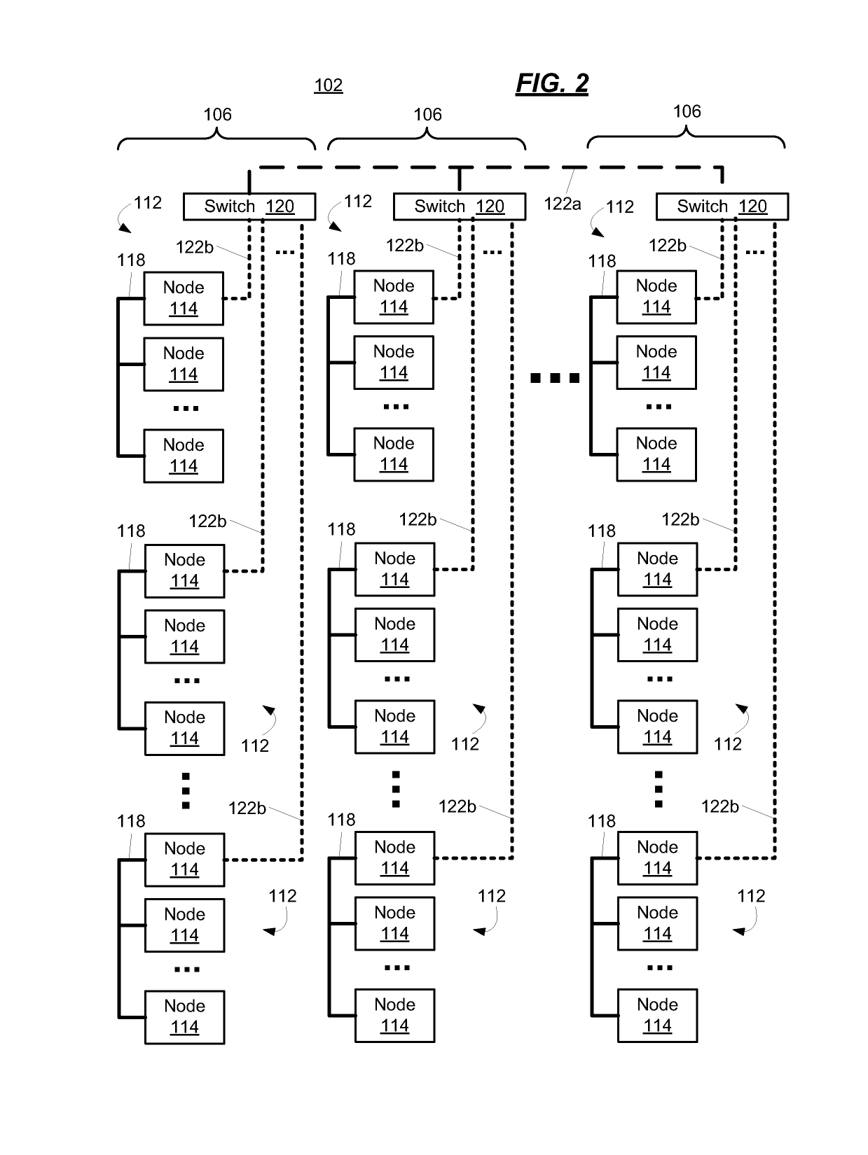

FIG. 3 is a block diagram illustrating the L1 switch 120 of FIGS. 1A and 1B. The L1 switch 120 is a 128-port L1 switch having sixty-four (64) inward-facing 10 Gb/s ports 124-0, 124-1, . . . , 124-63 (corresponding to the inward-facing portion 122b of the L1 network 122) and sixty-four (64) outward-facing 10 Gb/s ports 124-64, 124-65, . . . , 124-127 (corresponding to the outward-facing portion 122a of the L1 network 122). Each inward-facing port 124-0, 124-1, . . . , 124-63 is connected to each egress NIC in the container (64 total), while each outward-facing port 124-64, 124-65, . . . , 124-127 is connected to a corresponding L1 switch in each of the other containers in the data center (63 subtotal) as well as the data center's NOC 104 (one more for 64 total connections).

The inward-facing ports 124-0, 124-1, . . . , 124-63 may be copper ports (since the links are short) while the outward-facing ports 124-64, 124-65, . . . , 124-127 may be fiber optic (“fiber”) ports. Thus, there may be as many as sixty-four (64) fiber cables leaving each L1 switch 120a and 120b and, for containers employing redundancy and having two switches, 128 fiber cables leaving each container (e.g., containers 106-0, 106-1, . . . , 106-63) providing two fiber cables for connecting each container to up to 63 other containers 106-0, 106-1, . . . , 106-63 in the data center 100 plus two fiber cables for connecting each container to the NOC 104.

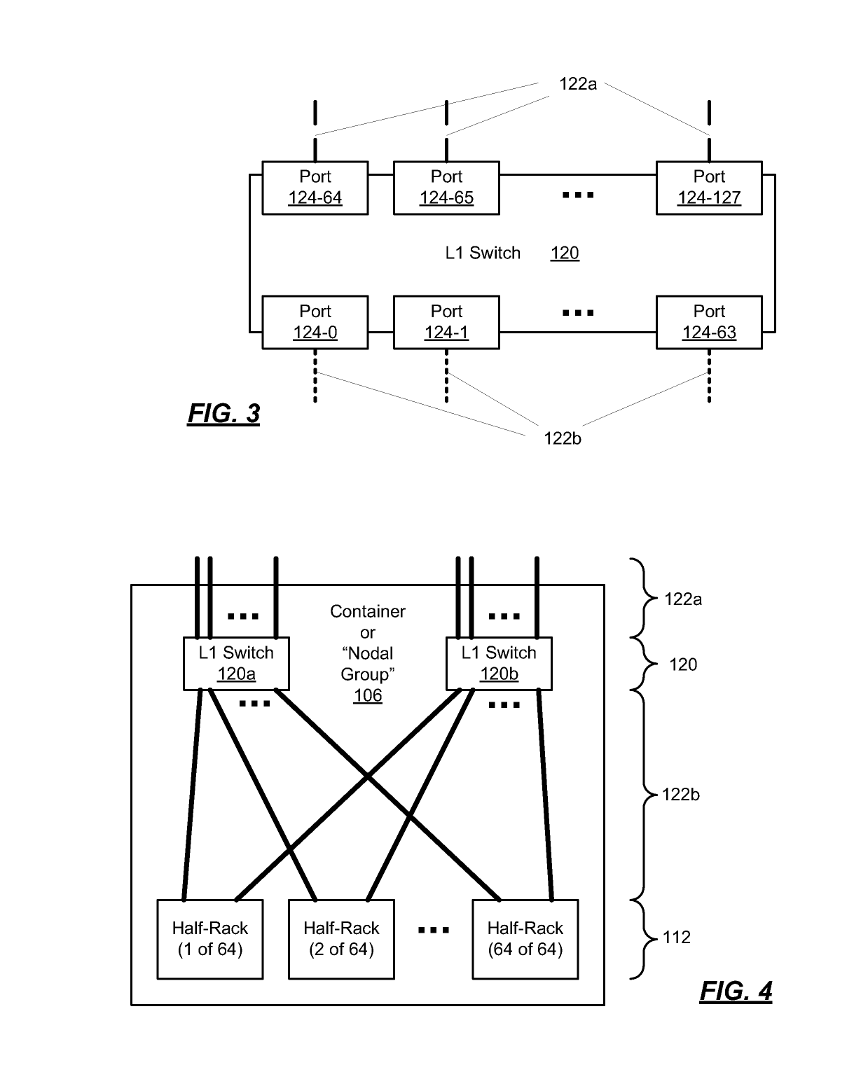

FIG. 4 is a block diagram illustrating the interconnectivity of the L1 switches 120a and 120b in the “nodal division” container 106 (representative of containers 106-0, 106-1, . . . , 106-63) coupled to the sixty-four (64) half-racks 112 within the nodal division 106. Each half-rack is coupled to both of the L1 switches 120a and 120b, and each of the L1 switches 120a and 120b connect to the other sixty-three (63) containers in the data center and the NOC 104. The two L1 switches 120a and 120b for each container provide failure-tolerance and additional communication bandwidth. Thus, if one L1 switch fails, the container for that switch (e.g., container 106-1) loses half of its bandwidth both to and from the half-racks and their servers (e.g., half-racks 112a and 112b, and servers 114-0, 114-1, . . . , 114-n, for example) as well as to and from the other containers and the NOC 104; nevertheless, full connectivity between all components in the data center 100 is still provided. For certain implementations, the two L1 switches 120a and 120b may be referred to as the primary and secondary switches respectively. Furthermore, given these configurations, “link-mapping” of the L1 switches 120 is possible, wherein for any two containers X and Y (where “X” and “Y” are container numbers from 0 to n, e.g., 0-63 for a sixty-four container data center), the link in Container X's port 64+Y connects to Container Y's port 64+X, and the NOC is connected to Container X's port 64+X and Container Y's port 64+Y respectively (which are the leftover ports on each switch respectively).

Unlike packet-switched networks, circuit networks—such as the circuit-based digital communications network 102 illustrated collectively in FIGS. 1-3—use circuit switching to route streams of digital data cells (e.g., 64-byte data cells) through the network, and paths through the network may be set up and torn down dynamically to send data traffic. Therefore, to optimize efficiency and speed, path setup and teardown is extremely fast to accommodate a mixture of short and long data flows.

For several implementations, path setup may be performed by the switches themselves and may be based on a unique destination address in the form of “C.H.P.”, for example, that specifies the container (C), the half-rack (H), and the egress NIC (P) (a.k.a., the egress NIC) and is supplied by the source of a particular flow as part of its request. Thus, for a container within a data center that is numbered within a range of 0 to 63, C uses six (6) bits in the destination address. Similarly, if half-racks within a container are numbered in the range of 0 to 63, H also uses six (6) bits. Likewise, if the egress NIC within the half-rack is numbered in the range 0 to 31, P will use five (5) bits. Hence, a C.H.P. destination address for such a configuration requires seventeen (17) bits. For different implementations, there may be “free code points” in the C.H.P. address space corresponding to non-existent NIC ports for configurations with fewer than 32 servers per half-rack, fewer than 64 half-racks per container, and/or fewer than 64 containers in the data center.

As demonstrated by the foregoing example implementations, knowing the topology of the network and the bandwidth of all the links therein simplifies switch design because no network-level flow control is needed and the network can (in the absence of a network failure) reliably deliver cells in order on each path (although if multiple slots per frame are used to achieve higher bandwidth, discussed further herein, delivery order may not be preserved since another path may have different latency).

Furthermore, such a network can reject connection requests during periods of overload (for later retry), whereas cells are never dropped once a connection is established (again, in the absence of a network failure). Additionally, such network systems may also feature “Valiant load balancing” (VLB) to provide more bandwidth than the single pair of links between a pair of containers could otherwise achieve by effectively routing additional traffic through an additional L1 switch (such as an L1 switch in a randomly-selected third container that is not on the normal direct path between the source and the destination) rather than directly to the destination, even though such a connection incurs an additional frame of latency (discussed further herein). Therefore, between two containers in a network, cells may transit up to three L1 switches between the source and destination of a route: an egress L1 switch in the source container, an intermediate L1 switch in another container (if needed), and an ingress L1 switch in the destination container. Likewise, data that is sent from one node to another node in the same container transits only a single L1 switch, while data that is sent from one node to another node in the same half-rack need not transit any L1 switches at all.

Because the L0 networks are smaller and much more localized than the L1 networks, a different method of routing may be employed in various implementations of the L0 networks. For example, the “L0 switches” (i.e., the NICs) may route data based on a destination-address using local routing tables that reflect the known topology of the particular L0 network. These tables are largely static and might only change (by a NIC processor in some implementations) if a node or link in the local L0 network fails. In addition, the L0 switches may use “cut-through forwarding” wherein the switch starts forwarding data before the whole has been received (normally as soon as the destination address is processed) in order to minimize latency.

Traffic in an L0 network may have both local traffic (which does not leave the L0 network) and remote traffic which passes through the L0 network to the L1 network through an egress node having an egress NIC comprising a 5th port (as discussed further herein). This 5th port in the egress node's switch (the egress NIC) connects to the L1 network through the L1 switch(es) to which the egress NIC is connected. Furthermore, within the L0 network, remote traffic may be routed with the highest priory but subject to any link capacity constraints (such as a constraint on the number of concurrent connections or flows that each link is allowed to carry). Moreover, capacity may also be constrained to be less than the entire link bandwidth such that the remaining capacity may be used for local traffic which, in any event, may be routed on a best-efforts basis. In addition, data may flow through the L0 networks in cells (as opposed to the frames used in the L1 network) by utilizing bandwidth reservation for flows to and from the L1 network and routing this traffic with the aforementioned highest possible priority while cut-through forwarding with link-by-link flow control may be used to minimize latency in these L0 networks.

For various implementations disclosed herein, the L1 switch send traffic in repeating frames, and each frame may have 128 repetitions of a 64-bit control slot followed by eight (8) 64-bit data slots (i.e., 64 bytes). The control slots contain two independent fields, one containing a control message (which may be null) and one containing the header (which also may be null) for the up to sixty-four (64) data bytes that follow it. When using 64b/66b encoding—which associates a 2-bit tag with each 64-bit data word)—only two of the four combinations (e.g., 10 and 01 but not 00 or 11) for the 2-bit tag may be deemed valid in order to guarantee a data transition at least once every sixty-six (66) bits which is used for clock recovery, and one value (e.g., 10) may indicate a control word while the other value (e.g., 01) may indicate a data word. For these various implementations, no further encoding is used. In contrast, data flows through the L0 networks in cells that are not framed, as discussed elsewhere herein.

With regard to L1 switches, control messages may be used for path setup requests to form a path from a source NIC (corresponding to a source node) to a destination NIC (corresponding to a destination node) as well as for responses sent by switches or destination NICs to source NICs. Generally, setup requests and payload data flow downstream from source to destination, while responses flow upstream; and thus it can be said that a particular switch receives setup requests from upstream and conversely receives responses from downstream. A control slot carries a control cell plus a data cell header (which may be null), while each data slot carries a data cell (which is either part of a particular flow or is a null cell). For several implementations, data cells are (a) carried over a connection (or “link”), (b) buffered at an input unit upon arrival, (c) forwarded through a “crossbar” to an output unit (discussed in more detail herein), and (d) sent over the next link.

When a path through the network is set up, each L1 switch on the path assigns a local slot to the flow. If there are 128 slots, a 7-bit slot number may be used and carried in the data cell header which, in turn, determines the input buffer (corresponding to a slot) for the payload data. The slot number is then modified at the output unit to pass the flow on to its next destination in the path, and thus control cells are generated by an output unit to be carried over a link for arrival and processing at an input unit.

The input unit processing of a control cell typically results in sending a “ring message” on a “ring interconnect” (or “ring”) that connects the input and output units. A message on the ring travels around the switch to an output unit, which as a consequence typically generates a control cell. Sending messages on the ring has much lower latency than sending them through the crossbar, since the data cells are delayed by at least a frame time at each switch, while the ring messages are not.

On the L0 network, where data headers and control cells are not combined into a single 64-bit field, the cell type may be used to imply the length of the cell (i.e., nine 64-bit words for data plus header, and one 64-bit word for control). In the L1 network, on the other hand, the data header and a control cells are packed into a single 64-bit word, and the number of bits used is determined by the largest control cell (i.e., a setup request) and the longest data cell header (i.e., a chunk mark header). The former uses 44 bits (after removing the flow control bits) and the latter uses 20 bits, and thus 64 bits are used for such implementations. To achieve this functionality, each L1 switch may be implemented using an input-buffered crossbar comprising a plurality of FPGAs.

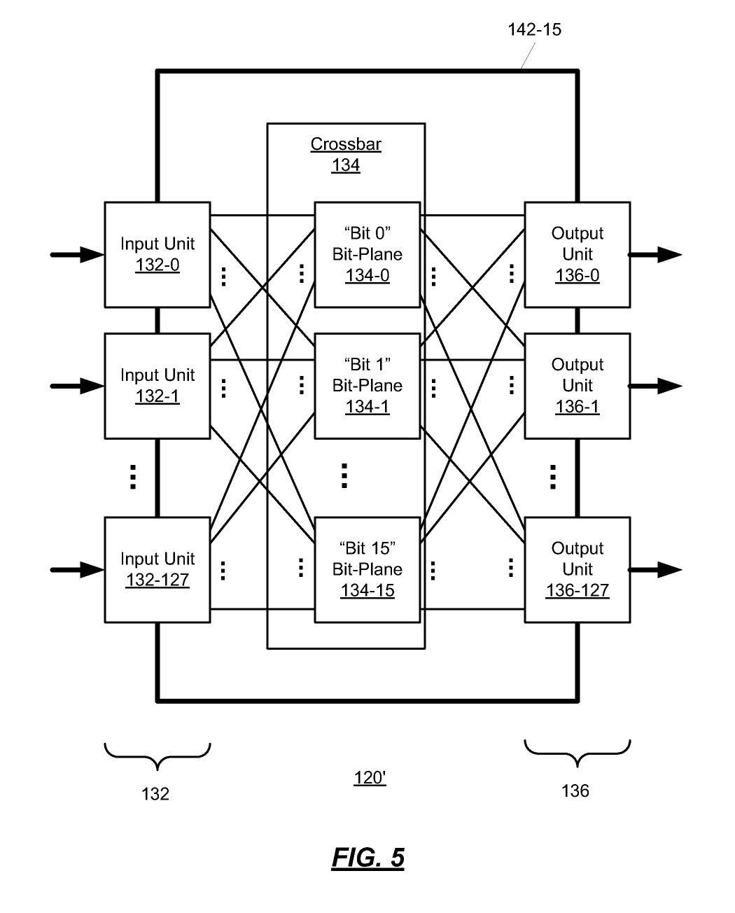

FIG. 5 is a block diagram of part of an exemplary internal structure 120′ for the L1 switch 120 of FIG. 3 which may be utilized by several implementations disclosed herein. The internal structure of the L1 switch 120 comprises 128 input units 132-0, 132-1, . . . , 132-128 (individually or collectively 132) which can be selectively coupled to the sixty-four (64) inward-facing ports 124-0, 124-1, . . . , 124-63 and sixty-four (64) outward-facing ports 124-64, 124-65, . . . , 124-127 of L1 switch 120 (see FIG. 3).

Similarly, the L1 switch 120 comprises 128 output units 136-0, 136-1, . . . , 136-127 (individually or collectively 136) which can also be selectively coupled to the sixty-four (64) inward-facing ports 124-0, 124-1, . . . , 124-63 and sixty-four (64) outward-facing ports 124-64, 124-65, . . . , 124-127 of the L1 switch 120 (see FIG. 3). Input units 132 and output units 136 are paired for serving each port, and thus each pairing can be thought of as an I/O unit with 128 total in an L1 switch. The L1 switch 120 further comprises a 128×128 crossbar 134 which features sixteen (16) logical bit-planes 134-0, 134-1, . . . , 134-16 (individually or collectively 134′), each bit-plane coupled (on a bit-slice basis) to each of the 128 input units 132 as well as to each of the 128 output units 136. (For several such implementations, although not shown in the illustration, the crossbar 134 may actually be implemented as seventeen (17) bit-slices wide in order to run the data cell type tag through the crossbar 134 at the same time as the data itself.) Also illustrated is a ring interconnect 138 that connects the input units 132 and output units 136.

In operation, an input units 132 receives a 10 Gb/s data flow which it bit slices into sixteen (16) parts and forwards these parts on a per-slice basis to the sixteen (16) bit-planes 134-0, 134-1, . . . , 134-15 of the crossbar 134. The crossbar 134, after “crossbarring” the flow, then forwards the resulting flow to the appropriate output unit 136—that is, the sixteen bit-planes 134-0, 134-1, . . . , 134-15 of the crossbar 134 forward their respective parts of the resulting flow on a per-slice basis to the appropriate output unit 136. This output unit 136 multiplexes this bit-sliced flow from the crossbar 134 and transmits it as a 10 Gb/s data flow accordingly.

In various implementations, eight input units and eight output units (i.e., eight I/O units) may be co-located on a single printed circuit board (PCB) to form a line card that serves eight (8) ports (or “links”) in the L1 switch, in which case 16 total line cards would be needed for a 128-port L1 switch 120. The line cards may also contains “ringmaster” logic shared by the eight I/O units, as well as random access memory (RAM) for any buffering or memory/storage needed by the I/O units. These line cards may each be implemented using FPGAs. The crossbar itself may also be bit-sliced over sixteen (16) additional FPGAs, each on its own PCB to form a total of sixteen (16) crossbar cards. The line cards and crossbar cards can be interconnected via a mid-plane PCB that carries signals between the line cards and the crossbar cards.

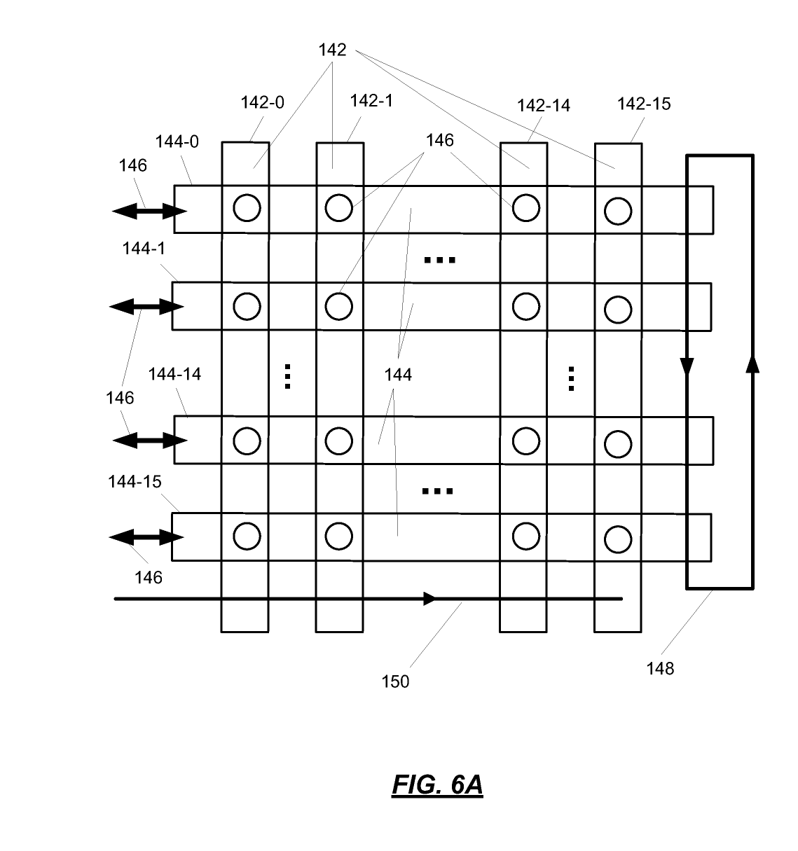

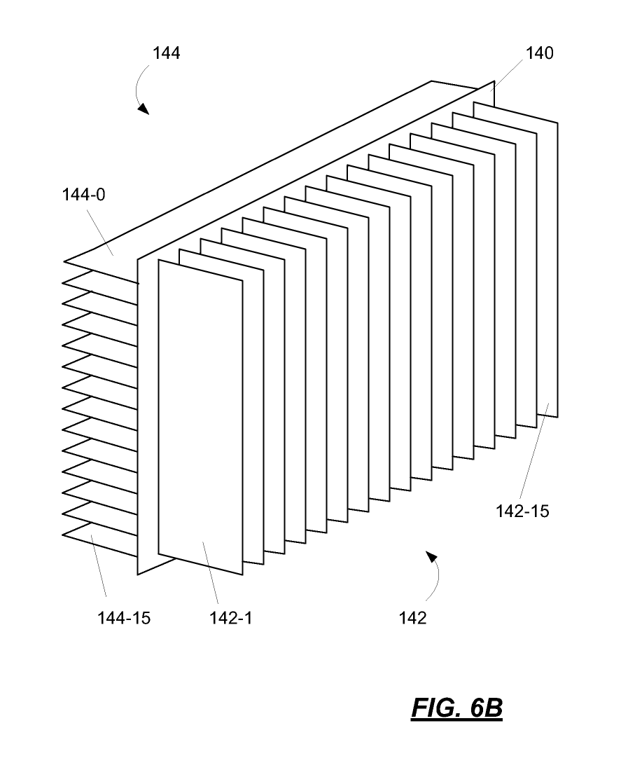

FIG. 6A illustrates an exemplary interconnection of line cards 144 and crossbar cards 142 for an L1 switch representative of several implementations disclosed herein. FIG. 6B is a perspective view of the line cards 144, crossbar cards 142, and midplane 140 of FIG. 6A. As illustrated, sixteen (16) line cards 144 (individually 144-0, 144-1, . . . , 144-15) are arranged orthogonally to sixteen (16) crossbar cards 142 (individually 142-0, 142-1, . . . , 142-15) and operatively coupled (shown as 256 interface points 146) through a midplane 140. The crossbar cards 142 are interconnected via a crossbar setup bus 150, while the line cards are interconnected via the line card ring 148. Each line bus card 144 also features eight (8) 10 Gb/s input/output links 146. 10 Gb/s link data arrives at a single 10.3125 10 Gb/s transceiver with 64b/66b coding as described earlier herein.

The core of the L1 switch 120 is the 128×128×32 crossbar. The crossbar is bit-sliced over 16 FPGAs, one per crossbar card and line card, and each of the FPGAs has 128 inputs and 128 outputs. Therefore, in the implementation shown in FIGS. 6A and 6B, the resultant data flow for each output link comes from thirty-two (32) 128:1 multiplexers and, as will be appreciated by skilled artisans, these 128:1 multiplexers may be constructed with 4:1 multiplexers. It should also be noted that each crossbar chip contains a copy of a schedule for each pair of 128:1 multiplexers that determines the input line selected by each multiplexer during each slot in a frame. As such, the schedule for one output line is 128 8-bit values.

Furthermore, for certain implementations, each crossbar card may contain only one crossbar chip having 128 data receivers, 128 pairs of 128:1 multiplexers, and 128 copies of the schedules for each crossbar output chip. It should be noted that is not necessary to track of the number of connections on the links to the L1 switches since the L1 switches can effectively do this themselves and reject connection requests that would exceed their link capacity.

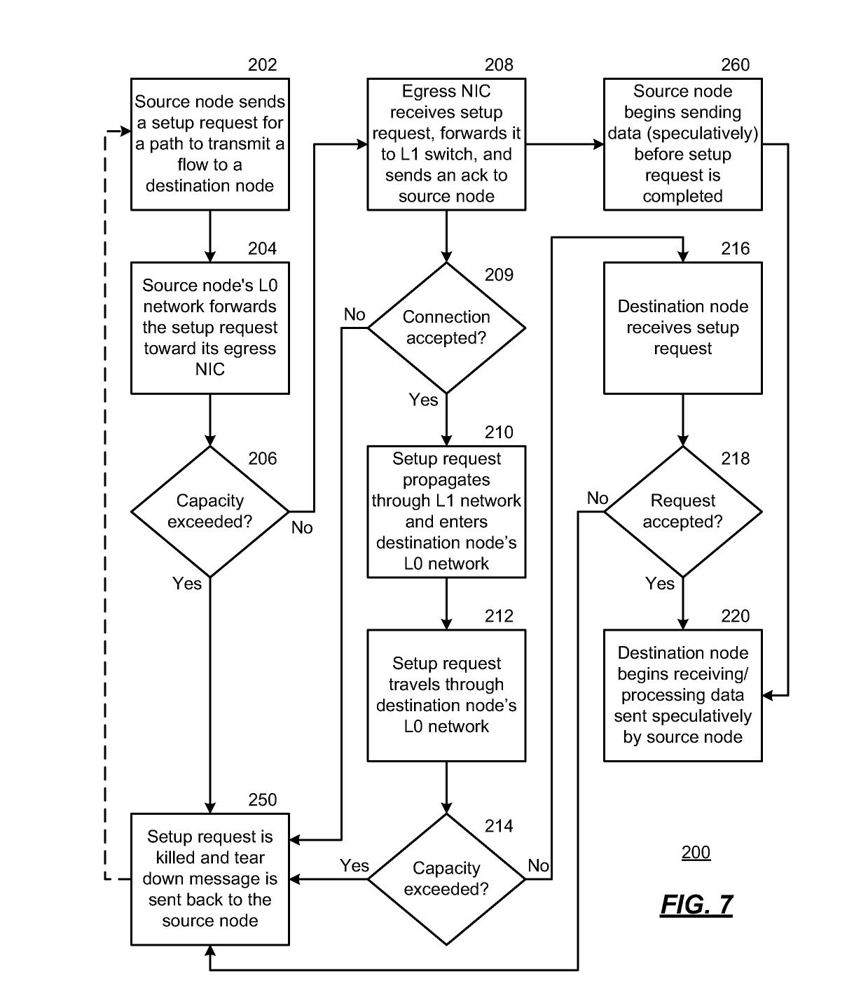

FIG. 7 is a process flow diagram illustrating an exemplary method 200 for setting up and tearing down connections for several implementations described herein. At 202, connection setup begins when a source node (or, more specifically, a source NIC or “SourceNIC”) sends a setup request for a path to transmit a flow to a destination node (or, more specifically, a destination NIC or “DestNIC”).

At 204, the source node's L0 network forwards the setup request along the L0 network towards that L0 network's egress NIC (a.k.a., “EgressNIC1”). Along the way, at 206, checks are made to see if the L0 network's capacity is exceeded and, if so, then at 250 the NIC on the L0 network that detects the condition kills the request and sends a tear down message back to the source node. Otherwise, the setup request reaches the egress NIC and, at 208, the egress NIC forwards the request to the L1 switch and send an acknowledgement (“ack”) to the source node. Upon receiving the ack, at 260, and while the setup request continues to be processed, the source node may begin sending data speculatively on the pathway that is being setup up.

Meanwhile, if the connection request is accepted by the L1 network at 209 (which is generally the case unless the output port capacity is full or the L1 switch fails to find a common slot between input and output), then at 210 the setup request continues to propagate through the L1 network (a maximum of 3 L1 switches), entering the destination L0 network at its egress NIC (a.k.a. “EgressNIC2”). At 212, the setup request passes through the destination node's L0 network towards the destination node. Along the way, at 214, checks are again made to determine if capacity (this time for destination node's L0 network) is exceeded. If so, then at 250 the NIC on the L0 network that detects the condition kills the request and sends a tear down message back to the source node (this time through the L1 network); otherwise, the setup request reaches the destination node at 216.

At 218, the destination node chooses whether to accept the setup request and, if not, then at 250 the destination NIC kills the request and sends a tear down message back to the source node; otherwise, at 220 the connection is open and the destination node begins receiving and processing data sent speculatively by the source node. The destination node does not need to respond to the setup request if it accepts the connection since the data flow is already being sent to it speculatively by the source node.

As will be appreciated by skilled artisans, the various implementations disclosed herein are a departure from current practice and should provide a substantial reduction in the capital cost for networking infrastructure in specific applications such as large data center utilization. In addition, the implementations disclosed herein reduce the complexity of network operations because the NOC may have full visibility and complete control of all the elements in the network.

FIG. 8 shows an exemplary computing environment in which example implementations and aspects may be implemented. The computing system environment is only one example of a suitable computing environment and is not intended to suggest any limitation as to the scope of use or functionality. Numerous other general purpose or specific purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well-known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A circuit-switched data center comprising:
a first circuit-switched network;
a second circuit-switched network implemented with a plurality of circuit switches, wherein the plurality of circuit switches interconnects an inward facing portion and an outward facing portion of the second circuit-switched network; and
a plurality of nodal divisions, each nodal division comprising a plurality of nodal groups, each nodal group comprising a plurality of nodes, wherein the plurality of nodes in each nodal group are interconnected on the first circuit-switched network local to each nodal group, wherein the plurality of nodal groups in each nodal division are interconnected on a local inward facing portion of the second circuit-switched network, and wherein the plurality of nodal divisions are interconnected on a remote outward facing portion of the second circuit-switched network.

2. The circuit-switched data center of claim 1, wherein at least one circuit-switch from among the plurality of circuit-switches comprises a crossbar.

3. The circuit-switched data center of claim 1, wherein the first circuit-switched network is connected to the second circuit-switched network via a network interface controller (NIC).

4. The circuit-switched data center of claim 3, wherein each circuit switch comprises at least one field programmable gate array (FPGA) and wherein the NIC comprises at least one application-specific integrated circuit (ASIC).

5. The circuit-switched data center of claim 1, further comprising a network operations center (NOC) interconnected with each nodal division on the outward facing portion of the second circuit-switched network.

6. The circuit-switched data center of claim 1, wherein at least one nodal division comprises at least two circuit switches with redundant interconnections.

7. The circuit-switched data center of claim 6, wherein the redundant interconnections are used to provide Valiant load balancing.

8. The circuit-switched data center of claim 1, wherein at least one nodal group comprises at least two redundant interconnections between the first circuit-switched network for the at least one nodal group and the second circuit-switched network.

9. The circuit-switched data center of claim 1, wherein:
each node is assigned a unique destination address based on a nodal division number, a nodal group number, and a node number;
the nodal division number corresponds to a port number on the plurality of circuit switches for the outward facing portion of the second circuit-switched network; and
the nodal group number corresponds to a port number on at least one circuit switch for the inward facing portion of the second circuit-switched network.

10. The circuit-switched data center of claim 1, wherein data is transmitted on the second circuit-switched network in a plurality of repeating frames, and wherein data is transmitted on the first circuit-switched network in a plurality of unframed cells.

11. The circuit-switched data center of claim 1, wherein at least one circuit switch comprises a plurality of line cards orthogonally interconnected to a plurality of crossbar cards.

12. The circuit-switched data center of claim 11, wherein each crossbar card from among the plurality of crossbar cards comprises at least one FPGA.

13. The circuit-switched data center of claim 12, wherein the plurality of line cards and the plurality of crossbar cards are interconnected via a midplane.

14. A circuit-switched digital communications network comprising:
a plurality of local circuit-switched networks each comprising a plurality of servers, each server comprising a network interface controller (NIC), wherein at least one server per local circuit-switched network comprises a NIC capable of connecting to a second network; and
a plurality of circuit switches wherein the circuit switches are coupled to each local circuit-switched network via the NIC capable of connecting to the second network, wherein the circuit switches perform switching on the second network, and wherein the circuit switches are interconnected.

15. The network of claim 14, wherein at least one circuit switch from among the plurality of circuit switches comprises:
a plurality of output units communicatively coupled to a plurality of crossbar cards wherein at least one crossbar card comprises an FPGA.

16. The network of claim 15, further comprising a plurality of multiplexers operatively coupled to the output units.

17. The network of claim 15, wherein an input flow is bit-sliced over the crossbar cards.

18. A method for transmitting data, the method comprising:
sending a setup request for a path for transmitting data to a destination node in a circuit-switched digital communications network; and
speculatively sending the data to the destination node before the setup request is completed.

19. The method of claim 18, wherein a tear down message is received if network capacity is exceeded.

20. The method of claim 18, wherein sending the data is completed unless a tear down message is received.
